(19) United States
(12) Patent Application Publication
(10) Pub. No.: US 2010/0299059 A1
(43) Pub. Date: Nov. 25, 2010

(54) Method for operating a navigation system and a navigation system

(76) Inventors: Andreas Vogel, Hildesheim (DE); Joerg Arnold, Ronnenberg (DE)

Correspondence Address: KENYON & KENYON LLP, ONE BROADWAY, NEW YORK, NY, 10004, US

(21) Appl. No.: 11/990,727

(22) PCT Filed: Jul. 21, 2006
(86) PCT No.: PCT/EP2006/064537

§ 371 Date: Jul. 16, 2010

(30) Foreign Application Priority Data
Aug. 19, 2005 (DE) 10 2005 039 283.0

(51) Int. Cl. G01C 21/00; G01S 19/42

(52) U.S. Cl. 701/201

(57) ABSTRACT

A method for operating a navigation system, in which position data is determined, a route to a destination is calculated on the basis of the position data and map data, and destination guidance instructions is created and issued according to the route. A deviation factor is ascertained for the position data and the destination guidance instructions are created as a function of the deviation factor. In addition, a navigation system 1 for carrying out the method is described.

### FIELD OF THE INVENTION

The present invention relates to a method for operating a navigation system, position data being determined, a route to a destination being calculated on the basis of the position data and map data, and destination guidance instructions being created and issued according to the route. The present invention also relates to a navigation system for carrying out the method.

### BACKGROUND INFORMATION

Navigation systems for vehicles and methods for operating such navigation systems are sufficiently well known. In general, the current position of the vehicle is determined and then a route to a predefined or entered destination is calculated. To this end, digitized map data of a road network or route network in a memory, for example a CD-ROM or a DVD, are accessed. The map data may include information about road courses, road classes, intersections, turning conditions, and points of interest. The quantity and precision of the information depends on the capacity of the memory employed.

The geographic position of the vehicle is now frequently ascertained via a satellite-based system, for example the global positioning system GPS or some other comparable system. Other site information may be determined, for example the direction of travel via a gyrometer, the speed of travel via speed sensors, and/or changes in travel via acceleration sensors.

An electronic data processing device, for example a microprocessor, determines the location of the vehicle on the basis of the ascertained position data and the map data of the digitized road map. Measuring errors of the sensors that occur may be corrected by the so-called “map matching” method, in which the information from various sensors is compared with the information from the stored map. If deviations are small it is assumed that the vehicle is on a permissible road, or one that is drivable according to the road map, and the location is corrected accordingly. To correct the position that is ascertained from the sensor data, the content of a digital map with the highest possible resolution (precision geometry or shape points) is therefore necessary. In the event of a greater deviation, the system interrupts the destination guidance with the notice that the user is not on a drivable road.

However, this method may not be utilized with digital maps that have only partial or no detailed geometry information. Such maps are utilized in so-called off-board navigation systems, in which the actual route calculation takes place in a central location and is conveyed to the vehicles through a transmission circuit. European Patent Document EP 1 380 021 B1 discusses a method for operating such an off-board navigation system, in which a present distance of the vehicle from a first decision point of a route to be traveled by the vehicle is analyzed constantly, and when the vehicle exceeds a minimum interval after passing the decision point a next decision point is defined.

In this method, as well as for example in the map matching method, it is always assumed during destination guiding that the ascertained position is correctly available. If the position deviates from the course of the roads, it is corrected to the course of the road as necessary and this corrected position of the vehicle is accepted as the correct location. Since there is no provision for an additional check, faulty destination guidance may result.

### SUMMARY OF THE INVENTION

Against this background, an object of the exemplary embodiments and/or exemplary methods of the present invention is to improve the navigation. This object is achieved by a method having the features described herein, as well as by using a navigation system having the features further described herein.

With a method of the type described above, the exemplary embodiments and/or exemplary methods of the present invention thus provides for a deviation factor to be ascertained for the position data and for the destination guidance instructions to be created depending additionally on the deviation factor. The essential idea here is that the ascertained position data remain unchanged, even if uncertainties are found for the position. When such uncertainties occur, the destination guidance is adjusted to this uncertainty in reference to the knowledge of the exact location. The driving recommendations are thus created and reported to the user in modified form.

In the case of increasing uncertainty about the exact position of the site, issuance of a correspondingly uncertain and possibly erroneous driving recommendation may be offset by skillful destination guidance instructions adapted to the situation. This may then result in the user not noticing a temporary uncertainty of position in the destination guidance. If the uncertainty in determining the location becomes too uncertain, this is not able to be hidden from the user. In this case the system does not pretend to provide an exactness of position to the user that is not currently guaranteed.

In an embodiment of the method according to the present invention, the deviation factor is ascertained depending on the position data of a satellite-based position determination, on measurement data from at least one sensor, on the map data of the calculated route, and/or on the basis of a stored driver profile. Here the method uses the available sensors present and installed in the vehicle, or part of those sensors. The information about the calculated route as well as a driver profile from which an appropriate road course may be derived on the basis of a particular driving behavior may be evaluated along with the sensor data. The derived road course may be compared with the map data.

For reliable destination guidance without distracting the user too much from what is happening in traffic, the destination guidance instructions are given visually and/or acoustically.

Advantageously, in a method according to the present invention, when a certain value of the deviation factor is reached in the destination guidance instructions, exact information is not issued about the distance from a next decision point. Instead of stating “turn right after 300 meters,” for example, the instruction may be “turn right at the next opportunity,” or the street name may be given, e.g. “turn right on Luisa Street.” Thus the driver receives the information he needs, without the uncertainty about the exact location being directly perceptible.

In order not to issue only inexact information in case of position uncertainty, an embodiment of the method according to the present invention may provide for a plurality of destination guidance instructions to be chained together in such a way that the destination guidance instruction referring to the next decision point on the route is created depending on the position data and on the deviation factor, and the destination guidance instructions referring to subsequent decision points are created depending on the respective preceding decision point.

In an advantageous method according to the present invention, the destination guidance instructions are issued at certain distances before the next decision point, and the distances become greater as the deviation factor grows. This results in the possibility of the user receiving the information in good time before a decision point, so that he is able to adapt to it, for example by changing lanes safely before a turning maneuver.

It may also be advantageous that when a map segment appears on a display the map segment is enlarged when the deviation factor reaches a certain value. The map segment may be displayed in a two-dimensional north plan view. By modifying the map scale, and in particular by changing a map display to a north-oriented map, the imprecision of the site position is compensated for, since incorrect position information is made less obvious. This may be supported further by changing the depiction of the location using a cursor from an arrow to a circle and thus not displaying the orientation of the vehicle.

In a refinement of the method according to the present invention, when a specified threshold value for the deviation factor is exceeded a warning is issued. This makes it evident to the user that an exact determination of position is not possible at that time. This in turn may yield the result that when the location uncertainty is too great no driving recommendation is able to be issued.

An advantageous embodiment of the method according to the present invention provides that when the deviation factor reaches a specified value a plausibility check based on the map data is performed, and the destination guidance instructions are created depending additionally on the plausibility check. If position inexactness is explainable based on the map data, for example because the vehicle is blocked from receiving the satellite signals when driving through a tunnel, allowance is able to be made for this in a situation-dependent manner.

In an embodiment of the navigation system according to the present invention, a display and/or a speaker are/is provided as output devices. This enables both visual and acoustic playback of the driving recommendations.

For exact determination of the location, a satellite-based positioning system is provided as the position-determining device. This may be, for example, the global positioning system GPS or the Galileo system. In addition to the normal signal information, the Doppler Effect from the satellite signals may also be utilized.

For additional advantageous position determination, at least one additional sensor is provided as an additional position-determining device in an embodiment of the navigation system according to the present invention. The navigation system is able to thus access the sensors which may be installed in the vehicle and their sensor data.

Finally, an embodiment provides for a stored driver profile in order to use the ascertained sensor values and the driver profile to derive a road course that may be compared with the map data.

The exemplary embodiments and/or exemplary methods of the present invention will be explained in greater detail below on the basis of an exemplary embodiment, referring to the attached drawing by way of example.

### BRIEF DESCRIPTION OF THE DRAWING

FIG. 1 shows a schematic sketch of a navigation system according to the exemplary embodiments and/or exemplary methods of the present invention.

### DETAILED DESCRIPTION

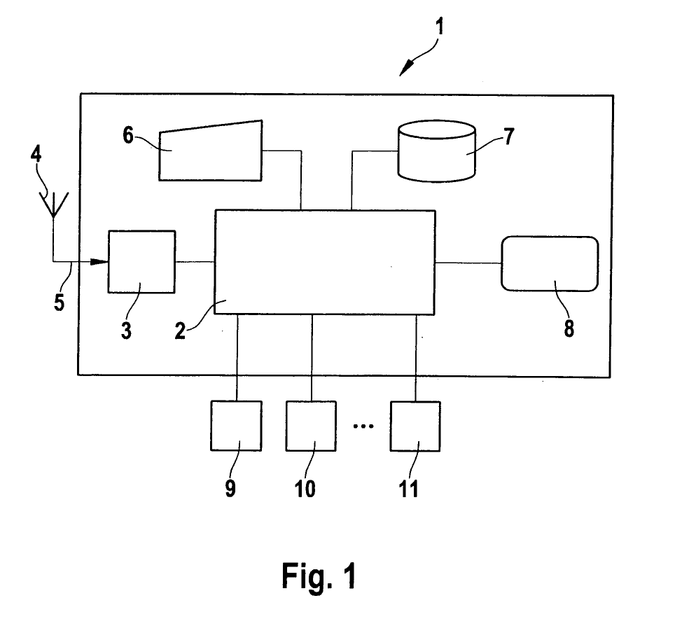

FIG. 1 shows a schematic sketch of a navigation system 1 according to the exemplary embodiments and/or exemplary methods of the present invention having a central data processing device 2, for example an electronic microprocessor. Data processing device 2 is connected to a position-determining device 3, which uses an antenna 4 mounted outside of navigation system 1 to receive radio signals, which are indicated by arrow 5 in FIG. 1. Radio signals 5 are signals of a satellite-based positioning system, for example the global positioning system GPS, the Galileo system, or a comparable system. Position-determining device 3 conveys the determined position data to data processing device 2.

Using an input device 6 the user of navigation system 1 may determine and enter a predefined destination in a known method. On the basis of the position data obtained from position-determining device 3, the destination data conveyed by input device 6, and map data that are stored in a memory 7, data processing device 2 calculates a route from the current position to the destination.

In addition to the position data from position-determining device 3, data processing device 2 receives additional data that may be evaluated to determine the position from a plurality of sensors 9, 10, 11 connected to navigation system 1. These may be, for example, a distance sensor, a speed sensor 9, acceleration sensors 10 for accelerations in various spatial directions, and/or a yaw rate sensor 11.

As an additional sensor, a geomagnetic field sensor or compass, for example, may be provided. Also conceivable are determinations of a wheel pulse difference for determining the yaw rate, of the steering angle, and/or of the pressure for measurements of altitude. Data processing device 2 does not have to access all of the available sensor data simultaneously, however, but rather it is sufficient to evaluate some of the possible sensors. Finally, the data of a calculated route and a stored driver problem are also available as sensors, since they may also be consulted to determine the position. The driver profile or driver profiles are stored in memory 7, and may be read from there by data processing device 2.

Corresponding to the calculated route and the position data with an ascertained deviation factor, destination guidance instructions are created by data processing device 2 and are communicated to the user of navigation system 1 via an output device 8. Output device 8 may have a read-out or display (not shown) for visual reproduction and/or a speaker (not shown) for acoustic reproduction of the destination guidance instructions.

The method according to the present invention is distinguished by the fact that it moves away from a constant demand for exact knowledge of the current position. Even in situations with reduced position-finding quality, driving recommendations or destination guidance instructions are issued to the user in an understandable and plausible manner. Based on the sensor data from all of the position-determining devices, the system checks whether the location registered with the sensor data corresponds to a point on the calculated route. A deviation factor which corresponds to a specification of estimated position uncertainty is ascertained through appropriate combination of the various sensor data from all of the systems and sensors appropriate for determining the position. The deviation factor is not a fixed number, but contains information about the uncertainty of the position (such as length and width), as well as for example about the speed, the direction of the vehicle, the altitude, etc. The deviation factor thus ascertained is consequently a relatively complex value.

In certain circumstances the measured sensor data may be compared with learned and stored driver profiles, in which a certain driving behavior is stored for corresponding road situations. These may be certain speed values and corresponding variances for roads categorized in a defined road class and/or typical acceleration or braking rates before and after curves. This makes it possible to bridge over short stretches when sensor data are missing, so that a site position is able to be estimated nevertheless.

With the help of the satellite-based positioning system, the current position is able to be determined with sufficient accuracy. However, this exact determination of location necessitates constant contact with the satellites that transmit the radio signals. However, reception of the radio signals may be disrupted by the current surroundings of the vehicle, for example when driving through canyons of tall buildings, mountain valleys, and/or a tunnel.

Criteria for uncertainty of position may be, for example, a deviation of more than 500 m or a directional error of more than 60°. The existence of too many contradictory positions within the digitized road network may also be used as a criterion. The ascertained deviation factor is taken into account when creating the driving recommendations, so that exact information about the distance from the current position to the next decision point is not issued when the deviation factor reaches a certain critical value.

However, additional driving recommendations beyond the next decision point may be reproduced exactly by chaining the driving recommendations, since they refer to the previous decision point. The information about distance between two decision points is able to be determined relatively precisely from the map data, and is thus independent of the current position. With chaining, a destination guidance instruction is designated which might state, for example: “turn right at the next opportunity and after 150 meters turn left.”

Because the inexactness of the position relates to the current position, exact distance information that is able to be derived from the map data of a digitized road network in memory 7 is able to continue to be stated exactly. Since the uncertainty increases with the distance, it makes sense to chain together and issue only a maximum number of destination guidance instructions, for example three, and to limit the maximum distance, for example to one kilometer. The point in time when these chained driving recommendations are issued is stored, in order to prevent confusing the driver by stating or issuing driving recommendations too frequently when improved, reliable position accuracy is again available.

In order to avoid presenting an accuracy of position to the driver that does not exist, the display of the destination guidance instructions may also be adapted to the situation. For example, the display shows only an arrow with the name of the street onto which the driver is to turn. An exact statement of distance is omitted here.

If map navigation is involved, the zoom level must be decreased. The scale of the displayed map is increased as a result, and the displayed segment of the map reproduces a larger territory of the road network. It is also possible to change from a (pseudo-)3D view to a north plan view, in which positioning errors are less obvious. This is particularly helpful for compensating for an angle error, i.e., the orientation of the vehicle. This is supported by changing the cursor from a directional arrow to a direction-independent circle, so that in a north depiction no conclusions may be drawn about the orientation of the vehicle.

If a critical threshold value for the deviation factor is exceeded, the user is given a warning message by device 8 to the effect that no serious driving recommendation is possible because of a position determination that is too inaccurate.

Through the above measures of the method according to the present invention, the navigation system constantly checks the accuracy of the position determination and adapts the destination guidance instructions to the uncertainty of the current position. The user thus does not receive driving recommendations that he would obviously recognize as imprecise or erroneous.

So as to prevent the change of the displays from making the user feel uncertain too frequently, it is possible, in the event of a growing deviation factor, first to check whether the increasing uncertainty in the position determination appears plausible on the basis of the stored map data. A disruption in satellite signal reception must be expected, for example, when driving through a tunnel or passing under a bridge. If the loss of information is found plausible, the duration of the expected blockage may be estimated as a result, and the driving recommendations to be issued along the route must be used to decide whether driving recommendations need to be given within the blocked segment.

The blocked segment may be estimated using the information from the map data and reasonable supplements. The driving instruction may be adjusted appropriately for such a blocked segment, for example “turn left in the tunnel” and/or “turn right after the tunnel.”

Additional measures are carried out when creating the destination guidance instructions of the type described above only if the loss of information is not able to be found plausible on the basis of the map data.

If there is temporarily no absolute position information available (satellite signal blockage) and there is no other adequate sensor system to enable linked positioning, it is assumed that the user is following the route. Thus the travel route is known, and it is only necessary to determine where the vehicle is on the route; hence the calculated route is available as an additional sensor. However, this only makes sense for bridging a brief segment of the route.

In addition to adapting the destination guidance instructions, it may be provided that the current position uncertainty or the deviation factor is indicated to the user on the display. This makes it obvious to the user at all times how precise the basis is for the issued driving recommendations.

1-15. (canceled)

16. A method for operating a navigation system, the method comprising:
determining position data;
determining a route to a destination based on the position data and map data;
creating and issuing destination guidance instructions according to the route; and
determining a deviation factor for the position data, wherein the destination guidance instructions are created depending on the deviation factor.

17. The method of claim 16, wherein the deviation factor is determined as a function of at least one of the position data of a satellite-based position determination, measurement data from at least one sensor, the map data of the calculated route, and based on a stored driver profile.

18. The method of claim 16, wherein the destination guidance instructions are output at least one of visually and acoustically.

19. The method of claim 16, wherein no exact information about the distance from a next decision point is output in the destination guidance instructions when the deviation factor reaches a certain value.

20. The method of claim 16, wherein a plurality of destination guidance instructions are chained together so that the destination guidance instruction referring to a next decision point on the route is created as a function of the position data and the deviation factor, and the destination guidance instructions referring to subsequent decision points are created as a function of respective previous decision points.

21. The method of claim 16, wherein the destination guidance instructions are issued at certain distances before the next decision point, and the distances become greater as the deviation factor grows.

22. The method of claim 16, wherein when a map segment appears on a display, the map segment is enlarged when the deviation factor reaches a certain value.

23. The method of claim 22, wherein the map segment is displayed in a two-dimensional north plan view.

24. The method of claim 16, wherein a warning is issued when the deviation factor exceeds a certain threshold.

25. The method of claim 16, wherein when the deviation factor reaches a specified value, a plausibility check based on the map data is performed, and the destination guidance instructions are created depending on the plausibility check.

26. A navigation system, comprising:
an input device for inputting a destination;
at least one position-determining device for determining position data;
a memory for storing map data of a road network;
a data processing device for determining a route to the destination based on the position data and map data, and for creating destination guidance instructions depending on the route; and
an output device for the destination guidance instructions;
wherein the data processing device is configured to determine a deviation factor for the position data, and to create the destination guidance instructions depending on the deviation factor.

27. The navigation system of claim 26, wherein at least one of a display and a speaker is provided as the output device.

28. The navigation system of claim 26, wherein the position-determining device includes a satellite-based positioning system.

29. The navigation system of claim 26, wherein there is at least one additional sensor as an additional position-determining device.

30. The navigation system of claim 29, wherein a stored driver profile is provided as an additional position-determining device.
